(19) United States
(12) Patent Application Publication
(10) Pub. No.: US 2011/0198985 A1
(43) Pub. Date: Aug. 18, 2011

(54) CRYSTALLINE COMPOUND, MANUFACTURING METHOD THEREFOR AND PLASMA DISPLAY PANEL

(76) Inventors: Osamu Inoue, Osaka (JP); Hiroshi Asano, Osaka (JP); Yayol Okui, Osaka (JP); Kojiro Okuyama, Nara (JP)

(21) Appl. No.: 12/989,622

(22) PCT Filed: Apr. 1, 2010
(86) PCT No.: PCT/JP2010/002405

§ 371 Date: Oct. 25, 2010

(30) Foreign Application Priority Data
May 25, 2009 (JP) 2009-124909

(51) Int. Cl. H01J 1/62; C01F 11/02; H01B 1/02

(52) U.S. Cl. 313/484; 423/594.9; 252/520.1

(57) ABSTRACT

The present invention aims to drive a PDP at low voltage by providing a material with a high secondary electron emission coefficient under a practical manufacturing condition. In order to achieve the aim, a crystalline oxide selected from the group consisting of CaSnO₃, SrSnO₃, BaSnO₃, and a solid solution of two or more of them, in which an amount of Ca, Sr or Ba in a surface region thereof is reduced, is used as a material for a protective film when a plasma display panel is produced.

### TECHNICAL FIELD

The present invention relates to a crystalline compound and a plasma display panel produced by using the crystalline compound.

### BACKGROUND ART

Plasma display panels (hereinafter, abbreviated as PDPs) have been in practical use and have rapidly become popular because they can easily be made in large sizes, are capable of high speed display, and are low cost.

A general PDP that is presently in practical use has a structure in which two glass substrates being front and back substrates are disposed so as to oppose each other, electrodes are arranged in a regular manner on each of the front and back substrates, and a dielectric layer made, for example, of a low melting glass is provided so as to cover each of the electrodes on the front and back substrates. On the dielectric layer formed on the back substrate, a phosphor layer is provided. On the other hand, on the dielectric layer formed on the front substrate, a protective layer made of MgO is provided in order to protect the dielectric layer from ion bombardment and improve secondary electron emission. In a space between the two substrates, a gas mainly composed of an inert gas such as Ne and Xe is enclosed.

In such a PDP, discharge occurs when voltage is applied to electrodes, and images are displayed by causing phosphors to emit light by the discharge.

There has been a strong demand for improving luminous efficiency of a PDP. As a method for improving the luminous efficiency, a method of lowering dielectric constant of the dielectric layer and a method of increasing partial pressure of Xe in a discharge gas are known.

Use of such methods, however, gives rise to the problem that firing voltage and sustaining voltage are increased.

In addition, since a cell size is reduced due to a recent increase in definition of a display, there has been a problem of further increase in discharge voltage.

As a solution to these problems, it is known that the firing voltage and the sustaining voltage can be reduced by using a material with a high secondary electron emission coefficient as a protective layer, and costs can be lowered by using an element with high efficiency and low voltage resistance.

In Patent Literatures 1 and 2, for example, CaO, SrO and BaO that are alkaline earth metal oxides as with MgO but have a higher secondary electron emission coefficient than MgO, and a solid solution of these compounds are considered to be used instead of MgO.

Another method of stabilizing the alkaline earth metal oxides by mixing them with the other metal oxides, and forming a protective film by using the mixed compound is also disclosed. Patent Literature 3, for example, discloses a protective film that is made of BaTiO₃, BaZrO₃, BaSnO₃, BaNb₂O₆, BaFe₁₂O₁₉, and the like.

### CITATION LIST

### Patent Literature

### [Patent Literature 1]

Japanese Patent Application Publication No. S52-63663

### [Patent Literature 2]

Japanese Patent Application Publication No. 2007-95436

### [Patent Literature 3]

Japanese Patent Application Publication No. 2004-273158

### SUMMARY OF INVENTION

### Technical Problem

CaO, SrO, BaO and the like, however, are less chemically stable than MgO, and readily react with carbon dioxide in the air to produce carbonate.

Compounds obtained by mixing these materials with other metal oxides are much more stable than these materials alone. Alkaline earth metal atoms exposed on outermost particle surfaces of the compounds, however, are carbonized by carbon dioxide in the air. Furthermore, in a process of manufacturing PDPs, carbonization becomes advanced on the outermost particle surfaces of the compounds because various treatments such as a heat treatment are performed.

Once such carbonate are produced on particle surfaces of the compounds, the firing voltage and the sustaining voltage cannot be reduced as intended due to reduction of a secondary electron emission coefficient.

When small amounts of these compounds are produced on a laboratory scale, such degradation of secondary electron emission performance due to chemical reaction is avoidable by, for example, controlling atmospheric gases during operation. In a manufacturing plant, however, it is difficult to control atmosphere during the whole process. If such control were possible, it would cost too much.

Therefore, in the manufacturing plant, an aging time required to reduce drive voltage is greatly increased. A manufacturing condition requiring such a long aging time is impractical.

Another problem is that, when a protective film is made of a material other than MgO, the life of the protective film is reduced because the protective film shows low resistance against ion bombardment and thus a rate of sputtering caused by discharge gases that are generated during driving of a PDP becomes high.

For these reasons, although the use of a material with a high secondary electron emission coefficient has been considered, only MgO is in practical use as a material for the protective layer.

The present invention has been achieved in view of the above problems, and aims to drive a PDP at low voltage by providing a material with a high secondary electron emission coefficient under a practical manufacturing condition, and thereby improving efficiency of driving of the PDP.

### Solution to Problem

A material used in the present invention is a crystalline compound selected from the group consisting of (i) CaSnO₃, (ii) SrSnO₃, (iii) BaSnO₃, and (iv) a solid solution of two or more selected from the group consisting of CaSnO₃, SrSnO₃, and BaSnO₃, and having been treated so as to reduce a ratio of an amount of alkaline earths (a total amount of Ca, Sr, and Ba) to an amount of Sn in a surface region thereof. At this time, it is desirable that a ratio by which a total amount of Ca, Sr, and Ba has been reduced be in a range of 5% to 50% inclusive in the surface region of the crystalline compound.

In order to reduce the total amount of Ca, Sr, and Ba in the surface region of the crystalline compound, it is preferable that surfaces of the crystalline compound be cleaned by using a polar solvent, in particular, by using a solvent including water as a main component.

The material used in the present invention is also a crystalline compound selected from the group consisting of (i) CaSnO₃, (ii) SrSnO₃, (iii) BaSnO₃, and (iv) a solid solution of two or more selected from the group consisting of CaSnO₃, SrSnO₃, and BaSnO₃, and having been treated such that a molar ratio of alkaline earths to Sn in a surface region thereof is less than 1.

The above-mentioned material of the present invention is disposed in a PDP so as to face a discharge space as an electron emissive material. Regarding a form of disposing the electron emissive material, it is desirable that the material be dispersed on an MgO protective layer in particulate form.

### Advantageous Effects of Invention

The above-mentioned electron emissive material of the present invention is a crystalline oxide selected from the group consisting of (i) CaSnO₃, (ii) SrSnO₃, (iii) BaSnO₃, and (iv) a solid solution of two or more selected from the group consisting of CaSnO₃, SrSnO₃, and BaSnO₃, and therefore, it is chemically stabilized and basically has a high secondary electron emission coefficient. In addition, it has been treated so as to reduce a ratio of an amount of one or more of Ca, Sr, and Ba, or a total amount of Ca, Sr, and Ba in outermost surfaces thereof. Therefore, even when carbonate exists on surfaces of the crystalline oxide before the treatment, an amount of carbonate is reduced by the treatment. Furthermore, carbonization is less likely to proceed on the surfaces of the crystalline oxide after the treatment.

Therefore, by disposing the electron emissive material in a PDP so as to face a discharge space, a PDP that can be driven at low voltage under a practical manufacturing condition can be provided.

When the crystalline oxide as the electron emissive material is dispersed on a surface of a conventional MgO protective layer that shows high resistance against ion bombardment, a PDP that can be driven at low voltage and has a long life can be provided.

### BRIEF DESCRIPTION OF DRAWINGS

FIG. 1 is a perspective view of a PDP according to the present invention.

FIG. 2 is a longitudinal sectional view of the PDP shown in FIG. 1.

FIG. 3 is a perspective view of another PDP according to the present invention.

FIG. 4 is a longitudinal sectional view of the PDP shown in FIG. 3.

FIG. 5 shows X-ray diffraction results of electron emissive materials in an embodiment of the present invention.

FIG. 6 shows results of valence band spectra of electron emissive materials in the embodiment of the present invention measured by XPS.

FIG. 7 shows results of C1s spectra of the electron emissive materials in the embodiment of the present invention measured by the XPS.

### DESCRIPTION OF EMBODIMENTS

First, electron emissive materials used in a PDP according to the present invention are explained below.

(Composition of Electron Emissive Materials)

The inventors synthesized a great variety of compounds by reacting CaO, SrO and BaO that have high secondary electron emission efficiency but are chemically unstable with a variety of oxides of metals such as B, Al, Si, P, Ga, Ge, Sn, Ti, Zr, V, Nb, Ta, Mo and W, and examined chemical stability and ability to emit secondary electrons of these compounds in detail. After the examination, the inventors found that, crystalline oxides of CaSnO₃, SrSnO₃, BaSnO₃, or a solid solution of two or more of them can improve chemical stability without significantly reducing secondary electron emission efficiency compared with the other compounds, and can reduce drive voltage compared with a case where MgO is used.

Outermost particle surfaces of these crystalline oxides, however, have been carbonized. Therefore, when PDPs are actually manufactured by using these crystalline oxides, it is necessary to remove carbon dioxide from particle surfaces of these crystalline oxides by performing aging processing for a long time, which is impractical. After conducting a review of a means to prevent the particle surfaces of these crystalline oxides from being carbonized, the inventors reached the present invention.

The inventors found that, by subjecting the crystalline oxides to treatment to reduce an amount of alkaline earths on particle surfaces thereof, the crystalline oxides are chemically stabilized. In addition, by performing the treatment, the crystalline oxides with a high secondary electron emission coefficient and whose particle surfaces are less likely to be carbonized can be obtained.

Here, in CaSnO₃, SrSnO₃, BaSnO₃, or a solid solution of two or more of them, a site for an alkaline earth may be partially substituted with La being a trivalent metal, a site for Sn may be partially substituted with In and Y being trivalent metals and Nb being a pentavalent metal, and O may be partially substituted with F. At this time, when a site is substituted with a metal having larger number of valence electrons (e.g. when an alkaline earth is partially substituted with La, and Sn is partially substituted with Nb), stability is improved but secondary electron emission efficiency is slightly reduced. On the contrary, when a site is substituted with a metal having smaller number of valence electrons (e.g. when Sn is partially substituted with In), stability is slightly reduced but secondary electron emission efficiency is improved. Therefore, by such substitution, it becomes possible to finely adjust properties of the compounds. In particular, substitution of In for Sn advantageously improves secondary electron emission efficiency. Note that it is possible to partially substitute a site for Sn with Ce or Zr.

When substitution is performed in such a manner, however, main components in composition have to be an alkaline earth, Sn and O. When a site for Sn is substituted with In, for example, although all sites for Sn can be substituted, a substitution ratio is required to be set to less than 50%. It is desired to be 20% or less, or 10% or less.

Note that, in CaSnO₃, SrSnO₃, BaSnO₃, or a solid solution of two or more of them, before cleaning treatment, a ratio of the total number of moles of alkaline earths to the number of moles of Sn, namely (Ca+Sr+Ba)/Sn, is basically 1 in a particle. By performing the above-mentioned treatment to reduce an amount of alkaline earths in a surface region of the crystalline oxides, however, the ratio of the total number of moles of alkaline earths to the number of moles of Sn, namely (Ca+Sr+Ba)/Sn, is reduced to be less than 1 in the surface region of the particle.

When CaSnO₃, SrSnO₃, BaSnO₃, or a solid solution of two or more of them are formed, it is desirable that the ratio of the total number of moles of alkaline earths to the number of moles of Sn, namely (Ca+Sr+Ba)/Sn, be set to be 0.995 or less in a surface region of a particle in order to stabilize the particle surfaces. This is because of the following reason. Even when the ratio is 1.000, a compound including a large amount of an alkaline earth such as a Ba₃Sn₂O₇ phase can be formed in a reaction process of an alkaline earth oxide material with SnO₂ due to compositional heterogeneity. Once the compound including a large amount of an alkaline earth is formed, such a phase covers particle surfaces. Furthermore, under conditions in which atmosphere is not controlled, it is considered that the particle surfaces are destabilized because, for example, BaCO₃ is separated out, resulting in a reduction in a secondary electron emission coefficient.

Note that when sites for an alkaline earth or Sn are partially substituted as described above, it is preferable that the ratio be set to be 0.995 or less with respect to the total number of moles of substituted elements. When the ratio is further lowered, surplus SnO₂ is separated out at a certain ratio or lower, and thus a mixture of the compound and SnO₂ is formed. Even in such a state, the above-mentioned effect of suppressing formation of the compound including a large amount of an alkaline earth can be obtained.

(Synthetic Method of Crystalline Compounds)

As a method for synthesizing a crystalline oxide selected from the group consisting of CaSnO₃, SrSnO₃, BaSnO₃, or a solid solution of two or more of them, there are a solid phase method, a liquid phase method, and a gas phase method.

In the solid phase method, base powders (e.g. a metal oxide, and metal carbonate) including each metal are mixed, and reacted by heat treatment at a certain temperature or higher.

In the liquid phase method, a solid phase is precipitated in a solution including each metal, or the solution is applied to a substrate, dried, heat-treated at a certain temperature or higher and the like to form a solid phase. The gas phase method is, for example, deposition, sputtering, and CVD. A membranous solid phase can be obtained in this method.

Although any of these methods can be used, the solid phase method is normally preferred for powdery materials because manufacturing costs are relatively low and mass production is possible.

(Reduction of Amount of Alkaline Earth in Surface Region of Crystalline Oxide)

Treatment is performed to reduce an amount of alkaline earths in a surface region of the crystalline oxide. In the treatment, a ratio of an amount of alkaline earths (amounts of Ca, Sr, and Ba, or a total amount of these) to an amount of Sn is reduced in a surface region of each particle of the crystalline oxide. The “surface region” here indicates a region on the particle that can be measured by XPS (X-ray Photoelectron Spectroscopy).

Specifically, in order to reduce an amount of alkaline earths in a surface region of the crystalline oxide, a method such as sputtering may be used. The alkaline earths, however, dissolve in polar solvents, including water, and a water and alcohol solvent mixture. Therefore, it is normally easy and practical to perform cleaning treatment in the presence of water. As cleaning water, pure water may be simply used, or an acid solution, an alkaline solution, and a mixture with an organic solvent may be used to control a ratio and an amount of dissolved alkaline earths. It is not preferable to perform cleaning treatment by using too strong acid, because crystalline oxides CaSnO₃, SrSnO₃, BaSnO₃ themselves are dissolved.

The purpose of the cleaning treatment is to remove alkaline earths and carbonate of the alkaline earths in a surface region of a particle. An amount of carbonate removed from a surface region of a particle can be measured by using a surface analytical method. For example, the XPS (X-ray Photoelectron Spectroscopy) is effectively used. The XPS is for measuring a spectrum of an electron that is emitted by X-irradiating a sample surface. In general, an analyzing depth thereof is considered to range from some atomic layers to more than a dozen atomic layers. The above-mentioned “surface region” falls within the range of the analyzing depth, and has a depth of 20 Å or less in a direction from uppermost particle surfaces to a core of the particle.

When the peak intensity of alkaline earths and the peak intensity attributable to carbonate are measured after and before the cleaning treatment by the XPS to obtain an amount of alkaline earths and an amount of carbon attributable to carbonate reduced in a surface region of a particle, a ratio at which alkaline earths are removed from particle surfaces and a ratio at which carbon attributable to carbonate is removed from particle surfaces can be measured.

A ratio at which alkaline earths are removed from particle surfaces(%)=[1−(the peak intensity after the cleaning treatment/the peak intensity before the cleaning treatment]×100

It is preferable that the ratio be in a range of 5% to 50% inclusive. The reason is as follows. When the ratio is less than 5%, an effect of preventing carbonization is reduced. On the other hand, when the ratio is more than 50%, an excessively large amount of alkaline earths is removed from particle surfaces, and an effect of reducing drive voltage is reduced.

After a detailed examination, the inventors found that materials capable of reducing discharge voltage in a PDP can be selected to some extent by measuring and comparing an energy position of a valence band edge and an amount of carbon attributable to carbonate by the XPS.

This is because of the following reason. By the XPS, information about a sample surface that is closely linked to secondary electron emission in a PDP can be obtained. It is generally considered that the smaller a sum of a band gap width and electron affinity is, the higher a secondary electron emission coefficient is. The secondary electron emission coefficient becomes high when an energy position of a valence band edge is on a low energy side because a band gap width becomes small at the time.

On the other hand, in a compound that includes alkaline earth metals, the amount of carbon attributable to carbonate on the sample surface provides an indication of chemical stability. When a sample is chemically unstable, the sample readily reacts with carbon dioxide in the air and thus an amount of carbon on a sample surface is increased. When the amount of carbon reaches or exceeds a certain amount, particle surfaces are completely covered by alkaline earth carbonate such as BaCO₃ having a low secondary electron emission coefficient. In this case, even when the energy position of a valence band edge is on a low energy side, a high secondary electron emission coefficient cannot be obtained.

Therefore, by measuring and comparing an energy position of a valence band edge and an amount of carbon attributable to carbonate by the XPS, and selecting a material whose energy position of a valence band edge is on a low energy side and have a small amount of carbon, the material suitable for reducing discharge voltage in a PDP can be selected to some extent.

The inventors also found that observation of changes in a specific surface area are effective to determine the degree of the cleaning treatment. In the cleaning treatment, alkaline earth metals on particle surfaces are selectively eluted. On the other hand, tin is not eluted but remains on the particle surfaces. As a result, since the particle surfaces become uneven at the atomic level, the specific surface area increases as the cleaning treatment progresses.

(Position and Form when Electron Emissive Material is Disposed)

Regarding a position in a PDP at which the crystalline oxide subjected to treatment to reduce alkaline earths in a surface region thereof is disposed, generally, it may be disposed on a dielectric layer that covers electrodes formed on a front plate. The crystalline oxide, however, may be disposed on another part such as a phosphor layer and a surface of a rib, or may be mixed into phosphors. In this case, an effect of reducing drive voltage can be obtained compared with a case where the crystalline oxide is not disposed, as long as it is disposed on a part facing a discharge space.

Regarding a form of disposing the crystalline oxide, for example, when the crystalline oxide is disposed on the dielectric layer that covers the electrodes formed on the front plate, it is considered that a film made of the crystalline oxide is disposed, or a powder of the crystalline oxide is dispersed, on the dielectric layer instead of an MgO film that is usually disposed as a protective layer. Alternatively, after the MgO film is formed, the film made of the crystalline oxide may be disposed, or the powder of the crystalline oxide may be dispersed, on the MgO film.

Although the crystalline oxide has a high melting point and is stable, when the crystalline oxide is disposed instead of a protective layer, sputtering resistance and transparency of the crystalline oxide are a little lower than those of the MgO film. When a powder of the crystalline oxide is dispersed, degradation of brightness due to low transparency can become a further problem. For these reasons, it is desired that the MgO film be used as a protective layer as before, and the powder of the crystalline oxide be dispersed on the MgO film at a level not causing the transparency problem. It is preferable that a covering ratio of the powder of the crystalline oxide be 20% or less in order not to cause the transparency problem.

When the crystalline oxide is used as a powder, particle sizes thereof may be selected for, for example, cell sizes from within a range of approximately 0.1 μm to 10 μm. When the powder is dispersed on the MgO film, however, it is preferable that the particle sizes thereof be 3 μm or less, or desirably 1 μm or less in order not to cause movement or a fall of the powder on the MgO film.

With such a structure, an MgO film having a high melting point serves as a protective layer, and the crystalline oxide subjected to the surface treatment plays a role in secondary electron emission. In addition, since the covering ratio of the powder of the crystalline oxide is low, reduction in brightness is prevented. Consequently, a PDP that can be driven at low voltage and has a long life can be obtained.

Note that the crystalline oxide disposed on the MgO film is not limited to one type of crystalline oxide. Two or more types of crystalline oxides selected from the group consisting of CaSnO₃, SrSnO₃, BaSnO₃, and a solid solution of two or more of them may be mixed with each other after the surface treatment is performed, and then the mixture may be disposed on the dielectric layer or the MgO film.

In order to solve a problem of discharge delay due to an increase in definition of a PDP, a crystalline MgO powder having high initial electron emission efficiency has recently been dispersed on the MgO protective layer. As a method for dispersing the powder, the following method is adopted. An MgO powder is mixed with organic ingredients to form a paste. The paste is, then, printed on the MgO protective layer. After the printing, the MgO protective layer is heat-treated at a certain temperature to remove the organic ingredients.

Accordingly, by a method similar to the above-mentioned method, the powder of the crystalline oxide subjected to the surface treatment and the crystalline MgO powder may be dispersed on the MgO protective layer, and then the MgO protective layer may be heat-treated at a certain temperature to remove the organic ingredients.

In this case, a paste of the MgO powder and a paste of the crystalline oxide subjected to the surface treatment may be separately prepared, and these pastes may be separately printed. It is desirable, however, that a paste including (i) the powder of the crystalline oxide subjected to the surface treatment and (ii) the crystalline MgO powder be prepared and then printed on the MgO protective layer, because the two types of the powders can be dispersed in one process.

As described above, by dispersing (i) the powder of the crystalline oxide subjected to the surface treatment and (ii) the crystalline MgO powder on the MgO protective layer, three functions to protect the dielectric layer, to reduce voltage, and to resolve the problem of discharge delay are fulfilled by the MgO film, the powder of the crystalline oxide subjected to the surface treatment, and the crystalline MgO powder, respectively.

Therefore, compared with a case where the three functions are fulfilled only by the MgO film, when the three functions are shared by the MgO film, the powder of the crystalline oxide subjected to the surface treatment, and the crystalline MgO powder, the three functions can be enhanced more easily. The above-mentioned method is suitable for enhancing the three functions in a PDP.

(Notation of Compound)

In the Specification, a crystalline oxide is described, for example, as BaSnO₃. Sn, however, is an element that tends to partly be Sn²⁺ in addition to Sn⁴⁺. An oxygen defect occurs in this case. Therefore, more accurately, the crystalline oxide should be described as BaSnO₃₋δ. δ here, however, changes depending on manufacturing conditions and the like and is not necessarily a constant value.

Therefore, the crystalline oxide is described as BaSnO₃ for the sake of convenience. For this reason, such notation does not deny an existence of the oxygen defect. The same applies to compounds other than BaSnO₃.

(Structure of PDP)

The following describes a specific example of a PDP of the present invention with use of drawings.

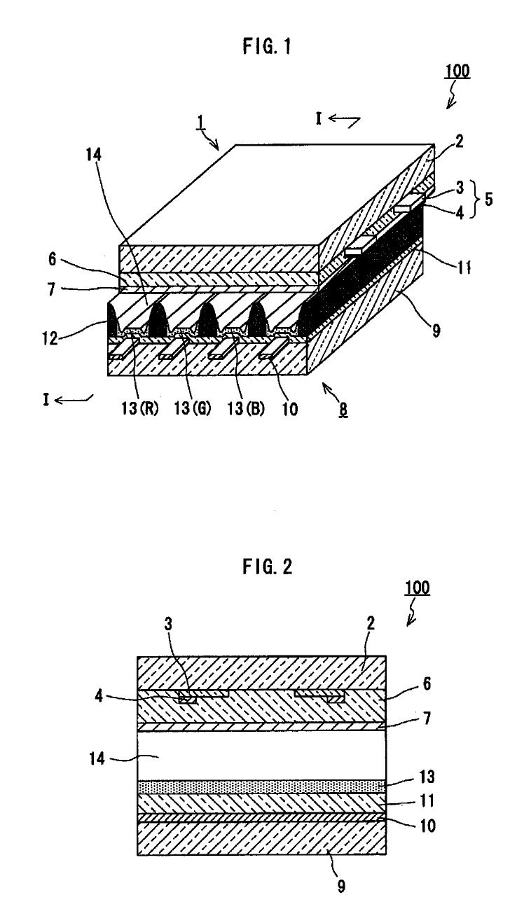

FIGS. 1 and 2 show an example of a PDP 100 according to the present invention. FIG. 1 is an exploded perspective view of the PDP 100, and FIG. 2 is a longitudinal sectional view (a sectional view taken along a line I-I of FIG. 1) of the PDP 100.

As shown in FIGS. 1 and 2, the PDP 100 includes a front panel 1 and a back panel 8. A discharge space 14 is formed between the front panel 1 and the back panel 8. The PDP 100 is a surface discharge AC-PDP, and has a structure similar to a structure of a conventional PDP except that a protective layer is made of the above-mentioned powder of the crystalline oxide.

The front panel 1 includes a front glass substrate 2; display electrodes 5 each composed of a transparent conductive film 3 that is provided on an inner surface (on a surface facing the discharge space 14) of the front glass substrate 2 and a bus electrode 4; a dielectric layer 6 that is provided so as to cover the display electrodes 5; and a protective layer (an electron emission layer) 7 that is provided on the dielectric layer 6. Each of the display electrodes 5 is formed such that the bus electrode 4 made of Ag and the like for ensuring good conductivity is laminated to the transparent conductive film 3 made of ITO or tin oxide.

The protective layer (the electron emission layer) 7 is made of the above-mentioned crystalline oxide subjected to the surface treatment.

The back panel 8 includes a back glass substrate 9; address electrodes 10 that are provided on one surface of the back glass substrate 9; a dielectric layer 11 that is provided so as to cover the address electrodes 10; barrier ribs 12 that are provided on an upper surface of the dielectric layer 11; and a phosphor layer of each color that is provided between the barrier ribs 12. Regarding the phosphor layer of each color, a red phosphor layer 13 (R), a green phosphor layer 13 (G) and a blue phosphor layer 13 (B) are arranged in that order.

As phosphors that constitute the phosphor layer, for example, BaMgAl₁₀O₁₇:Eu can be used as blue phosphors, Zn₂SiO₄:Mn can be used as green phosphors and Y₂O₃:Eu can be used as red phosphors.

The front panel 1 and the back panel 8 are joined using a sealing member (not illustrated) such that longitudinal directions of the display electrodes 5 are orthogonal to longitudinal directions of the address electrodes 10, and the display electrodes 5 and the address electrodes 10 face each other.

A discharge gas that is composed of a rare gas component such as He, Xe and Ne is enclosed in the discharge space 14.

Each of the display electrodes 5 and the address electrodes 10 is connected to an external drive circuit (not illustrated). Discharge occurs in the discharge space 14 by applying voltage from the drive circuit, and the phosphor layer 13 is excited to emit visible light by short wavelength ultraviolet light (147 nm wavelength) that is generated along with the discharge. The above-mentioned compound is used to form the protective layer 7.

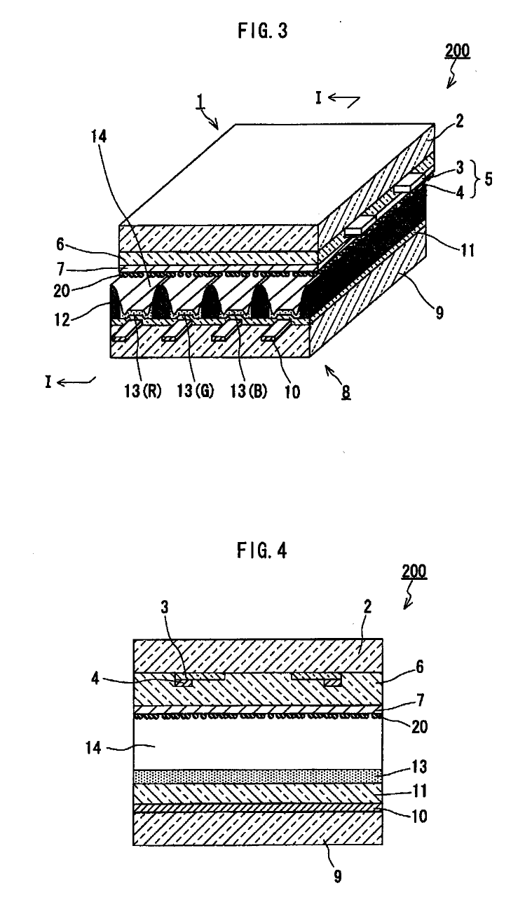

FIGS. 3 and 4 show another example of a PDP according to the present invention. FIG. 3 is an exploded perspective view of a PDP 200. FIG. 4 is a longitudinal sectional view (a sectional view taken along a line I-I of FIG. 3) of the PDP 200. The PDP 200 includes (i) the protective layer 7 made of MgO and (ii) an electron emission layer 20 that is formed by dispersing, on the protective layer 7, the electron emissive material made of the above-mentioned crystalline oxide subjected to the surface treatment.

In the PDP 200, since the electron emission layer 20 formed by using the electron emissive material faces the discharge space 14, the effect of reducing drive voltage can be produced.

Note that, in the present invention, the electron emissive material may be provided on any part of the PDP 200 that faces the discharge space 14. The electron emissive material, for example, may be provided on the barrier rib, or the phosphor layer. In addition, a PDP in which the electron emissive material is provided is not limited to a surface discharge PDP, and may be an opposing discharge PDP. Furthermore, it is not necessarily a PDP that includes a front plate, a back plate and barrier ribs. It only needs to be a PDP in which discharge is caused in a discharge space by applying voltage between electrodes, and phosphors emit visible light along with the discharge to cause the PDP to emit light. For example, in a PDP that includes a plurality of discharge tubes in which phosphors are provided and emits light by causing discharge inside of each of the discharge tubes, drive voltage can be reduced by providing the electric emission material inside each of the discharge tubes.

(Manufacturing Method of PDP)

As a manufacturing method of a PDP, here, a method for manufacturing a PDP by using an MgO film as the protective layer 7, and dispersing the electron emissive material made of the crystalline oxide subjected to the surface treatment on the protective layer 7 as with the above-mentioned PDP 200 is described first.

First, a front plate is produced. A plurality of linear transparent electrodes are formed on one major surface of the flat front glass substrate. After silver pastes are applied to the transparent electrodes, the entire front glass substrate is heated to bake the silver pastes, and thus the display electrodes are formed.

A glass paste that includes glass for the dielectric layer is applied to the major surface of the front glass substrate by a blade coater method so as to cover the display electrodes. The entire front glass substrate is, then, held at 90 degrees Celsius for 30 minutes to dry out the glass paste, and subsequently baked at about 580 degrees Celsius for 10 minutes.

A magnesium oxide (MgO) film is formed on the dielectric layer by an electron beam deposition method, and baked to form the protective layer. The baking temperature at the time is approximately 500 degrees Celsius.

After a paste of a mixture of a vehicle such as ethyl cellulose and a powder of the compound of the present invention is prepared, the paste is applied to the MgO layer by a printing method and the like, dried out, and baked at about 500 degrees Celsius to form a dispersion layer.

Next, a back plate is produced. After a plurality of linear silver pastes are applied to one major surface of the flat back glass substrate, the entire back glass substrate is heated to bake the silver pastes, and thus the address electrodes are formed.

After glass pastes are applied between adjacent address electrodes, the entire back glass substrate is heated to bake the glass pastes, and thus barrier ribs are formed.

After phosphor inks of colors of R, G and B are applied between adjacent barrier ribs and the back glass substrate is heated at about 500 degrees Celsius to bake the phosphor inks, the phosphor layer is formed by eliminating resin components (binders) and the like in the phosphor inks.

The front and back plates thus obtained are sealed together with use of sealing glass. The temperature at the time is approximately 500 degrees Celsius. Thereafter, the inside of the sealed plates is evacuated to a high vacuum and then filled with a rare gas. The PDP is produced in the above-mentioned manner.

On the other hand, as in the case of the above-mentioned PDP 100, when the protective layer 7 made of the crystalline oxide subjected to the surface treatment is formed on the dielectric layer 6, the protective layer 7 may be formed in the following manner. The powder of the crystalline oxide subjected to the surface treatment is mixed with a vehicle, a solvent, and the like to form a paste with relatively high powder content. The paste is, then, spread on the dielectric layer 6 by a method such as the printing method, and baked to form a thin or thick film.

Alternatively, when the powder of the crystalline oxide subjected to the surface treatment is dispersed on the dielectric layer 6, a paste with relatively low powder content may be dispersed by the printing method, or a solvent in which the powder is dissolved may be dispersed by a method such as a spin coat method.

Note that the above-mentioned structure and manufacturing method of a PDP are just examples, and the present invention is not limited to these.

### EMBODIMENTS

The following describes the present invention in more detail based on embodiments. In the embodiments, BaSnO₃ and SrSnO₃ that are selected from the group consisting of CaSnO₃, SrSnO₃, BaSnO₃, and a solid solution of two or more of them are used to synthesize powders. The synthesized powders are, then, subjected to cleaning treatment to reduce an amount of Ba or Sr on particle surfaces thereof. Note that, when CaSnO₃, or a solid solution of two or more selected from the group consisting of BaSnO₃, CaSnO₃, and SrSnO₃, are used, similar effects can be obtained.

### Embodiment 1

(Synthesis of BaSnO₃ Crystalline Oxide and Surface Treatment)

Guaranteed reagent or purer BaCO₃ and SnO₂ were used as starting materials. After these materials were weighed so that an atomic ratio of Ba to Sn is 1:1, the weighed materials were wet blended with use of a ball mill, and dried out to obtain a mixed powder. The obtained mixed powder was placed into a crucible, and baked in the air at 1100 degrees Celsius, thereby obtaining a baked powder with an average particle size of 0.49 μm (No. 1 in Table 1).

Next, after the baked powder was weighed to obtain a certain amount of the baked powder, the obtained powder was added to pure water or aqueous hydrochloric acid solution according to each condition (No. 2 to 6) shown in Table 1. After the pure water or the aqueous hydrochloric acid solution to which the obtained powder had been added was stirred to mix the obtained powder for a certain period of time, a powder was extracted by filtration, and dried out. Here, although cleaning treatment is performed by using pure water in both No. 2 and 3 in Table 1, the cleaning treatment performed in No. 3 is more powerful than that performed in No. 2 because a weight ratio of water to the powder in No. 3 is higher than that in No. 2. On the other hand, since the cleaning treatment is performed by using hydrochloric acid in No. 4 to 6, the cleaning treatment performed in No. 4 to 6 is more powerful than that performed in No. 2 and 3. Additionally, the cleaning treatment performed in No. 6 is more powerful than that performed in No. 4 because a larger amount of acid is used as the number increases. That is to say, in No. 2 to 6, the cleaning condition gets more powerful as the number increases.

A powder in No. 7 was obtained by baking a part of a powder in No. 6 in Table 1 again in the air at 1100 degrees Celsius.

For comparison, a powder obtained by mixing BaCO₃ with SnO₂ so that an atomic ratio of Ba to Sn is 0.95:1.00 and baking the mixture in the air at 1100 degrees Celsius was prepared (No. 8 in Table 1).

TABLE 1

| | | cleaning | conditions | | | | particle size | specific surface area | | working example or |
|---|---|---|---|---|---|---|---|---|---|---|
| No. | Ba:Sn | treatment | powder | water | 35% HClsol. | re-baking | (μm) | (m²/g) | area ratio | comparative example |
| 1 | 1:1 | — | — | — | — | not rebaked | 0.49 | 5.30 | 1.00 | comparative example |
| 2 | 1:1 | water 1 | 2 g | 50 g | — | not rebaked | 0.44 | 5.63 | 1.06 | working example |
| 3 | 1:1 | water 2 | 2 g | 100 g | — | not rebaked | 0.43 | 5.83 | 1.10 | working example |
| 4 | 1:1 | acid 1 | 2 g | 100 g | 0.025 g | not rebaked | 0.41 | 7.00 | 1.32 | working example |
| 5 | 1:1 | acid 2 | 2 g | 50 g | 0.06 g | not rebaked | 0.40 | 7.85 | 1.48 | working example |
| 6 | 1:1 | acid 3 | 2 g | 50 g | 0.60 g | not rebaked | 0.39 | 14.26 | 2.69 | working example |
| 7 | 1:1 | acid 3 | 2 g | 50 g | 0.60 g | rebaked | — | — | — | — |
| 8 | 0.95:1.00 | — | — | — | — | not rebaked | | — | — | comparative example |

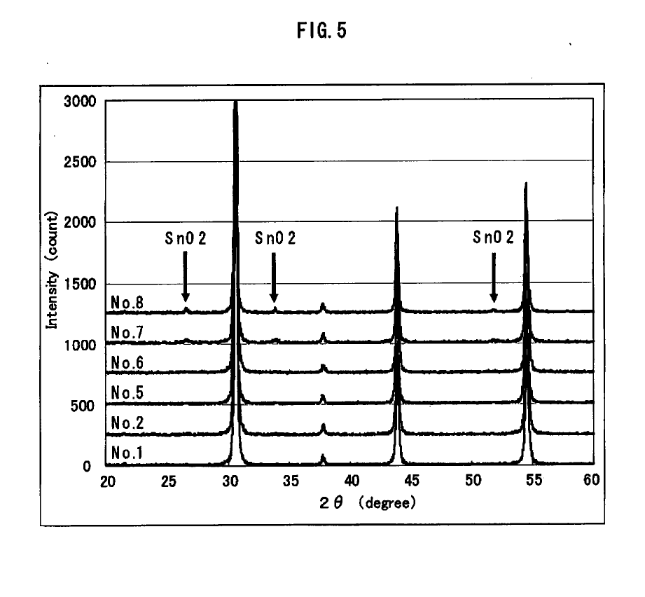

For each powder in No. 1 to No. 8, an average particle size was measured and a specific surface area was measured by using BET. The results of the measurement are shown in Table 1. For each sample No. 1, 2, 5, 6, 7, and 8, measurement was performed using X-ray diffraction (using CuKα ray). The results of the measurement are shown in FIG. 5.

As shown in FIG. 5, all diffraction peaks observed in the sample No. 1 are identical to peaks of BaSnO₃ having a perovskite structure. Regarding the samples No. 2, 5, and 6, which were obtained by subjecting the sample No. 1 to the cleaning treatment using water or acid, differences from No. 1 in results of the X-ray diffraction were not observed even in No. 6 subjected to the most powerful treatment. Note that, although not shown in FIG. 5, the differences from No. 1 were not observed in No. 3 and 4, which were under intermediate conditions of No. 2 and 5.

In No. 7, which was obtained by baking the sample No. 6 again, however, weak peaks appeared at locations indicated by arrows in FIG. 5. The locations of the peaks were the same as those observed in No. 8, which was synthesized by using a decreased amount of Ba. Therefore, the peaks can be identified as diffraction peaks of SnO₂.

On the other hand, in No. 1 to 6, which were not baked again, the diffraction peaks of SnO₂ were not observed. This indicates that an amount of Ba in a surface region of a particle is reduced but the effect of reducing the amount of Ba is limited only in the surface region of a particle.

Note that No. 7 is regarded as a comparative example, because an effect obtained by the cleaning treatment is eliminated. This is because of the following reason. In No. 7, a ratio of an amount of Ba to an amount of Sn was once reduced in a surface region of a particle by performing the cleaning treatment. By performing the baking treatment again, however, the effect was eliminated because composition in a surface region of a particle and composition inside the particle are leveled.

As for the particle sizes and the specific surface areas shown in Table 1, although particle sizes of the samples No. 2 to 6 subjected to the cleaning treatment are not significantly reduced compared with that of No. 1 not subjected to the cleaning treatment, specific surface areas of the samples in No. 2 to 6 are dramatically increased. Presumably, this is because of the following reason. The solubility of BaO in water and acid is higher than that of SnO₂. Therefore, by the cleaning treatment, Ba is selectively eluted but Sn remains in a surface region of a particle, and thus particle surfaces become uneven at the atomic level. Consequently, as the cleaning treatment progresses, a specific surface area is increased.

(XPS)

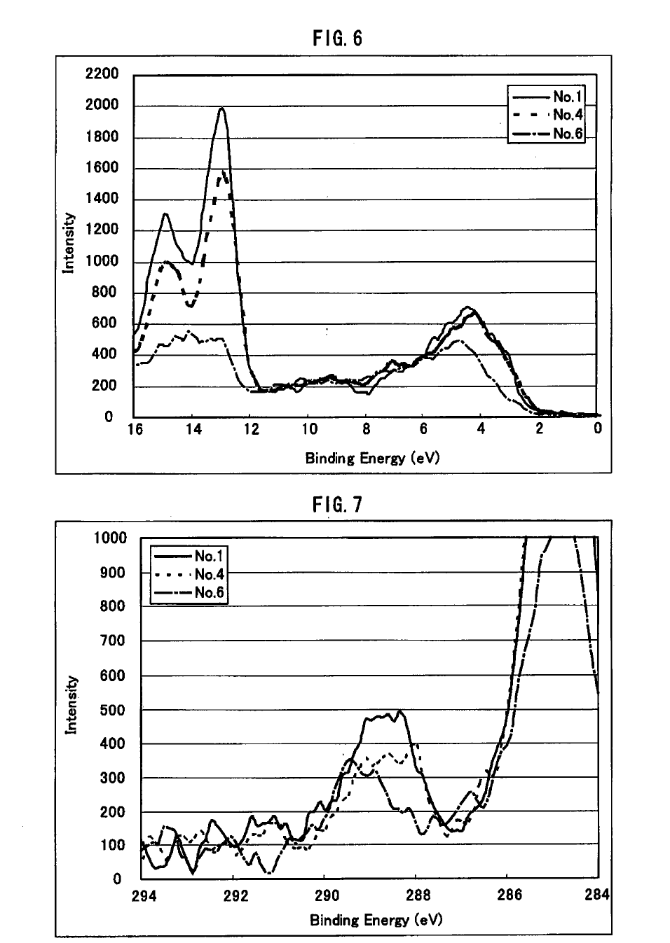

In order to observe a decrease of an amount of Ba in a surface region of a particle due to the cleaning treatment and effects thereof more directly, XPS measurement was performed for the particle powders. By way of example, valence band XPS spectra of samples No. 1, 4, and 6 in Table 1 are shown in FIG. 6, and C1s XPS spectra of samples No. 1, 4, and 6 in Table 1 are shown in FIG. 7. Note that background noises are eliminated in FIGS. 6 and 7.

In FIG. 6, peaks appearing at around 13 eV and 15 eV are attributable to Ba. Compared with No. 1 not subjected to the cleaning treatment, peak intensity is reduced in No. 4, and the peak intensity is further reduced in No. 6. From these results, it can be found that an amount of Ba in a surface region of a particle is reduced as the cleaning treatment becomes powerful.

On the other hand, as for a valence band edge position, the valence band edge position in No. 4 is almost the same as that in No. 1. The valence band edge position in No. 6, however, is shifted to a higher energy side. This is considered to be because an amount of Ba on particle surfaces is excessively reduced in No. 6.

Next, in FIG. 7, while a C peak attributable to carbonate appears in a range of about 288 to 290 eV, peak intensity is reduced in No. 4 and 6 subjected to the cleaning treatment, compared with No. 1 not subjected to the cleaning treatment. It can be found that an amount of C on particle surfaces is reduced by the cleaning treatment.

(XPS Measurement)

XPS measurement was performed for powders in No. 1 to 6, and 8 in Table 1, and for an MgO powder (No. 10) for comparison.

An amount of Ba, a valence band edge position, and an amount of C on particle surfaces are semi-quantitatively shown in Table 2. Specifically, Table 2 shows intensity of peaks appearing at around 13 eV that are attributable to Ba (the greater the peak intensity is, the larger the amount of Ba is.), intensity of peaks appearing at 3 eV (the valence band edge position is shifted to a lower energy side as the peak intensity becomes greater.), and intensity of C1s peaks appearing in a range of about 288 to 290 eV that are attributable to carbonate (the less the peak intensity is, the smaller the amount of C is and the more chemically stable the particle surfaces are.). Note that values of background noises are not included in the values shown in Table 2.

In addition, each of the above-mentioned powders was mixed with a binder and an organic solvent to form a paste, and the paste was printed on a glass substrate and baked in the air at 510 degrees Celsius to burn organic constituents. For a powder collected after the above-mentioned process (after thick film baking), the XPS measurement was performed. Table 2 also shows measurement results of intensity of C1s peaks attributable to carbonate after the thick film baking. Note that the process of baking the thick film is commonly used when a film is formed by using a powder and a powder is dispersed on an MgO film.

TABLE 2

| | | XPS intensity | | | | | |
|---|---|---|---|---|---|---|---|
| | | | | 3 eV | | C after thick film baking | working example or |
| No. | treatment | Ba (count) | Ba intensity ratio | (count) | C (count) | (count) | comparative example |
| 1 | untreated | 1990 | 1.00 | 420 | 500 | 740 | comparative example |
| 2 | water 1 | 1890 | 0.95 | 410 | 450 | 470 | working example |
| 3 | water 2 | 1830 | 0.92 | 370 | 410 | 390 | working example |
| 4 | acid 1 | 1570 | 0.79 | 350 | 400 | 370 | working example |
| 5 | acid 2 | 1020 | 0.51 | 240 | 380 | 390 | working example |
| 6 | acid 3 | 560 | 0.28 | 110 | 350 | 410 | working example |
| 8 | untreated | 1850 | — | 360 | 430 | 610 | comparative example |
| 10 | MgO powder | — | — | 50 | 550 | 870 | comparative example |

(Discussion Based on XPS Measurement Results)

As can be seen from the peak intensity attributable to Ba and the peak intensity attributable to C shown in Table 2, an amount of Ba and an amount of C on particle surfaces are reduced by the cleaning treatment. This indicates that, in BaSnO₃, carbonate (BaCO₃) generated in a surface region of a particle was washed away, and, after that, carbonate was less likely to be generated on the particle surfaces.

While an amount of C on particle surfaces is increased after the thick film is baked in No. 1 and 8 not subjected to the cleaning treatment and in No. 10, which is an MgO powder, an amount of C on particle surfaces is increased little or decreased in No. 2 to 6 subjected to the cleaning treatment.

The peak intensity at 3 eV in No. 2 to 6 subjected to the cleaning treatment is reduced compared with that in No. 1. The peak intensity at 3 eV in No. 6 is approximately a quarter of that in No. 1. This is because an amount of Ba on particle surfaces is extremely reduced by treatment using acid.

It is considered desirable that, like No. 2 to 5, Ba intensity after the cleaning treatment be at least 50% of Ba intensity before the cleaning treatment and that a specific surface area after the cleaning treatment approximately fall within a range of 200% of a specific surface area before the cleaning treatment.

(Manufacturing and Discharge Voltage Measurement of PDP)

In this embodiment, a PDP that is produced by using the powder of the crystalline oxide according to the present invention is shown. A flat front glass substrate that has a thickness of approximately 2.8 mm and is made of soda lime glass was prepared. ITO (a material of a transparent electrode) was applied to a surface of the front glass substrate in a predetermined pattern, and dried out. Next, after a plurality of linear silver pastes that are mixtures of a silver powder and an organic vehicle were applied, a plurality of display electrodes were formed by heating the front glass substrate to bake the above-mentioned silver pastes.

A glass paste was, then, applied, by a blade coater method, to a front panel on which the display electrodes were produced and dried out by being held at 90 degrees Celsius for 30 minutes. Thus, a dielectric layer having a thickness of approximately 30 μm was formed by baking the glass paste at 585 degrees Celsius for 10 minutes.

After magnesium oxide (MgO) was deposited on the dielectric layer by an electron beam deposition method, a protective layer was formed by baking the deposited magnesium oxide at 500 degrees Celsius.

Next, 1 part by weight of each powder in No. 1 to 6, and 8 was mixed with 100 parts by weight of an ethyl cellulosic vehicle, and the mixture was milled by using a three roller mill to form a paste. A thin layer of the paste was, then, applied to the MgO layer by a printing method. After being dried out at 90 degrees Celsius, the thin layer was baked in the air at 500 degrees Celsius. At this time, a ratio at which the MgO layer after the baking is covered with a powder was approximately 10%. For comparison, a PDP that includes only an underlying MgO film on which the paste is not printed was also produced.

On the other hand, a back plate was produced in the following manner. First, address electrodes that are mainly made of silver were formed in stripes on a back glass substrate made of soda lime glass by screen printing. A dielectric layer having a thickness of approximately 8 μm was, then, formed in a manner similar to the manner to form the dielectric layer on the front plate.

Next, barrier ribs were formed between adjacent address electrodes on the dielectric layer with use of glass pastes. The barrier ribs were formed by repeatedly performing screen printing and baking.

Red (R), green (G) and blue (B) phosphor pastes were, then, applied to walls of the barrier ribs and exposed surfaces of the dielectric layer between barrier ribs, dried out and baked to produce a phosphor layer.

The produced front plate and back plate were sealed together at 500 degrees Celsius with use of a sealing glass. After the air is evacuated from a discharge space, Xe is enclosed in the discharge space as a discharge gas, thus a PDP was produced.

The produced panel was connected to a drive circuit to emit light. After the panel is aged by being held for a predetermined period in a light emitting state, sustaining voltage was measured. Here, the aging is performed for cleaning surfaces of an MgO film and dispersed powders to some extent by sputtering. The aging is commonly performed in a manufacturing process of a PDP. When the aging is not performed, discharge voltage of a panel becomes high, whether powders are dispersed or not. The following Table 3 shows discharge voltage measurement results after the aging. Note that, No. 0 shows a measurement result of a panel that includes only an underlying MgO film on which the powder is not dispersed.

TABLE 3

| | discharge voltage (V) | | | | | |
|---|---|---|---|---|---|---|
| | after | after | after | after | | working example or |
| No. | 6 h | 12 h | 24 h | 100 h | note | comparative example |
| 0 | 225 | 234 | 245 | 249 | underlying | comparative example |
| | | | | | MgO film | |
| 1 | 235 | 236 | 224 | 222 | | comparative example |
| 2 | 227 | 224 | 222 | 222 | | working example |
| 3 | 225 | 223 | 222 | 221 | | working example |
| 4 | 224 | 223 | 222 | 221 | | working example |
| 5 | 228 | 225 | 223 | 224 | | working example |
| 6 | 231 | 228 | 227 | 229 | | working example |
| 8 | 232 | 231 | 222 | 221 | | comparative example |

(Discussion Based on Discharge Voltage Measurement Results)

As apparent from Table 3, voltage in No. 0 including only the underlying MgO film tended to be increased by the aging. In contrast, in No. 1 to 6 to which a BaSnO₃ powder was dispersed, voltage was reduced by the aging. Even after the voltage was reduced, the voltage was kept stable compared with the voltage in No. 0 including only the underlying MgO film.

When the time required for the reduction of discharge voltage was compared among No. 1 to 6, in No. 1 not subjected to the cleaning treatment, the reduction of discharge voltage was obviously insufficient after 12 hours of aging, and the reduction of discharge voltage was not enough after 24 hours of aging. In No. 8 in which a ratio of Ba is low, the reduction of discharge voltage was obviously insufficient after 12 hours of aging. The reason why a long time is required to reduce discharge voltage is that a long time is required to remove a large amount of C on particle surfaces by sputtering.

In contrast, in No. 2 to 6 subjected to treatment using water, discharge voltage is sufficiently reduced after 6 hours of aging. This is considered to be because an amount of C on particle surfaces is originally small, and the amount of C on particle surfaces is not likely to be increased during baking of the thick film.

Although discharge voltage is reduced after 24 hours of aging in 1 and 8, it is difficult to perform aging processing for such a long time in actual manufacturing facilities. If it were possible, it would cost too much and thus impractical. Therefore, it is clear that productivity is improved if discharge voltage is sufficiently reduced by short-term aging processing as in the cases of No. 2 to 6. In No. 6, however, a ratio by which the discharge voltage is reduced is less than that in No. 2 to 5. This indicates that the cleaning treatment performed in No. 6 is too powerful.

(Covering Ratio)

Next, by using a BaSnO₃ powder in No. 3 subjected to the cleaning treatment, pastes of different concentrations of BaSnO₃ were prepared. PDPs were, then, produced by using the prepared pastes so that covering ratios on the MgO film differ among PDPs. Each of the produced PDPs was connected to a drive circuit to emit light. After the panel is aged by being held for a predetermined period in a light emitting state, sustaining voltage was measured. The results of the measurement are shown in Table 4.

TABLE 4

| | covering | discharge voltage (V) | | | |
|---|---|---|---|---|---|
| No. | ratio (%) | after 6 h | after 12 h | after 24 h | after 100 h |
| 0 | 0 | 225 | 234 | 245 | 249 |
| 31 | 1.0 | 227 | 226 | 225 | 226 |
| 3 | 9.8 | 225 | 223 | 222 | 221 |
| 32 | 20.0 | 230 | 225 | 222 | 221 |
| 33 | 38.5 | 239 | 232 | 229 | 226 |
| 34 | 94.1 | 254 | 254 | 243 | 232 |

From the results shown in Table 4, it can be found that an aging time required to reduce voltage is increased as the covering ratio increases, and the reduction of voltage is not enough even after 100 hours of aging in No. 34 in which the covering ratio is almost 100%. Presumably, this is because of the following reason. The higher the covering ratio is, the larger the amount of powder is, and therefore, a longer time is required for cleaning particle surfaces.

Note that, the higher the covering ratio is, the larger an amount of light being lost is, and therefore, a PDP with a higher covering ratio is inferior in brightness.

On the other hand, in No. 31 in which the covering ratio is 1.0%, voltage is reduced by short-term aging processing. A ratio by which the voltage is reduced, however, is a little. Furthermore, voltage is slightly increased by long-term aging processing. These are considered to be because an amount of powder is small.

As described above, when the covering ratio is less than 1.0%, an effect of reducing voltage is reduced, whereas, when the covering ratio is more than 20%, a long time is required for aging. Therefore, it is desirable that the covering ratio be in a range of 1.0% to 20% inclusive.

### Embodiment 2

By a method similar to the method used in Embodiment 1, guaranteed reagent or purer SrCO₃ and SnO₂ were used as starting materials. After these materials were weighed so that an atomic ratio of Sr to Sn is 1:1, the weighed materials were wet blended with use of a ball mill, and dried out to obtain a mixed powder. The obtained mixed powder was placed into a crucible, and baked in the air at 1100 degrees Celsius, thereby synthesizing an SrSnO₃ powder.

Next, after the synthesized powder was weighed to obtain 2 g of the synthesized powder, the obtained powder was added to 100 g of pure water. After the pure water to which the obtained powder had been added was stirred to mix the obtained powder for a certain period of time, a powder was extracted by filtration, and dried out.

For the powders before and after treatment using water, a specific surface area was measured by using the BET. The specific surface area of the powder before the treatment was 3.44 m²/g, whereas the specific surface area of the powder after the treatment was 3.59 m²/g.

The powders before and after the treatment were both identified as SrSnO₃ having a perovskite structure by measurement using the X-ray diffraction, and there was no difference between them.

Next, similarly to Embodiment 1, each of the powders before and after the treatment was mixed with a binder and an organic solvent to form a paste, and the paste was printed on a glass substrate and baked in the air at 510 degrees Celsius to burn organic constituents. For a powder collected after the above-mentioned process (after thick film baking), the XPS measurement was performed.

Although a peak attributable to Ba appeared in a range of about 13 to 15 eV in BaSnO₃ according to Embodiment 1, a peak attributable to Sr appeared in a range of about 18 to 20 eV in SrSnO₃ according to Embodiment 2. A C peak attributable to carbonate, however, appeared in a range of about 288 to 290 eV similarly to the case of BaSnO₃.

For each of the powders before and after the treatment, an amount of Sr, a valence band edge position, and an amount of C in a surface region of a particle are semi-quantitatively shown in Table 5. Specifically, Table 5 shows intensity of peaks appearing in a range of about 18 to 20 eV that are attributable to Sr (the greater the peak intensity is, the larger the amount of Sr is.), intensity of peaks appearing at 3 eV (the valence band edge position is shifted to a lower energy side as the peak intensity becomes greater.), and intensity of C1s peaks appearing in a range of about 288 to 290 eV that are attributable to carbonate (the less the peak intensity is, the smaller the amount of C is and the more chemically stable the particle surfaces are.). Note that values of background noises are not included in the values shown in Table 5.

TABLE 5

| | | XPS intensity | | | | | |
|---|---|---|---|---|---|---|---|
| | | | | | | C after thick film baking | working example or |
| No. | treatment | Sr (count) | Sr intensity ratio | 3 eV (count) | C (count) | (count) | comparative example |
| 21 | untreated | 2810 | 1.00 | 180 | 470 | 550 | comparative example |
| 22 | water | 2560 | 0.91 | 170 | 420 | 400 | working example |

As apparent from Table 5, an amount of Sr and an amount of C in a surface region of a particle are reduced by the cleaning treatment. In the powder not subjected to the cleaning treatment, although an amount of C in a surface region of a particle is increased after the thick film is baked, an amount of C in a surface region of a particle is not increased in the powder subjected to the cleaning treatment.

The reason why a ratio of an amount of Sr to an amount of Sn in a surface region of a particle is reduced by the treatment using water is that SrO is more soluble in water than SnO₂. Similarly, the reason why an amount of C in a surface region of a particle is reduced by the treatment is that carbonate (SrCO₃) generated in the surface region of the particle are washed away by the treatment.

By a method similar to the method used in Embodiment 1, a PDP with a covering ratio of 10% was produced using each of the powder subjected to the treatment and the powder not subjected to the treatment. Then, discharge voltage was measured after 12 hours of aging. While discharge voltage in a PDP produced using the powder not subjected to the treatment was 237 V, discharge voltage in a PDP produced using the powder subjected to the treatment was no less than 226 V and the reduction of discharge voltage was observed even after short-term aging.

Note that, in Embodiments 1 and 2, an effect of reducing, by the treatment using water, a ratio of an amount of Ba and Sr to Sn in a surface region of a crystalline compound of BaSnO₃ and SrSnO₃ was confirmed. As with BaO and SrO, CaO is more soluble in water than SnO₂. Accordingly, when CaSnO₃ is subjected to the treatment using water, a ratio of an amount of Ca to an amount of Sn in a surface region of a particle is reduced.

Similarly, in Embodiments 1 and 2, an effect of reducing, by the treatment using water, an amount of C in a surface region of a crystalline compound of BaSnO₃ and SrSnO₃ was confirmed. As with carbonate (BaCO₃ and SrCO₃) generated in a surface region of a particle, carbonate (CaCO₃) generated in a surface region of a particle is washed away by the treatment using water. Accordingly, when CaSnO₃ is subjected to the treatment using water, an amount of C in the surface region of the particle is reduced.

Similarly, when a solid solution of two or more selected from the group consisting of SrSnO₃, BaSnO₃, and, CaSnO₃ is subjected to the treatment using water, a ratio of amounts of Sr, Ba, and Ca to an amount of Sn in a surface region of a particle is reduced, and an amount of C in a surface region of a particle is reduced because carbonate (SrCO₃, BaCO₃, and, CaCO₃) generated in the surface region of the particle is washed away.

### INDUSTRIAL APPLICABILITY

The present invention can provide electron emissive materials that have high γ, are chemically stable, and have small amounts of C on particle surfaces, and thus is effective to improve discharge characteristics of a plasma display panel.

### REFERENCE SIGNS LIST

1 front panel
2 front glass substrate
3 transparent conductive film
4 bus electrode
5 display electrode
6 dielectric layer
7 protective layer
8 back panel
9 back glass substrate
10 address electrode
11 dielectric layer
12 barrier rib
13 phosphor layer
14 discharge space
20 electron emission layer

1. A crystalline compound selected from the group consisting of (i) CaSnO₃, (ii) SrSnO₃, (iii) BaSnO₃, and (iv) a solid solution of two or more selected from the group consisting of CaSnO₃, SrSnO₃, and BaSnO₃, and having been treated so as to reduce a ratio of an amount of one or more of Ca, Sr, and Ba to an amount of Sn in a surface region thereof.

2. The crystalline compound of claim 1, wherein
a ratio by which a total amount of Ca, Sr, and Ba has been reduced as a result of the treatment is in a range of 5% to 50% inclusive.

3. The crystalline compound of claim 1, wherein
the treatment is cleaning treatment using water.

4. A crystalline compound selected from the group consisting of (i) CaSnO₃, (ii) SrSnO₃, (iii) BaSnO₃, and (iv) a solid solution of two or more selected from the group consisting of CaSnO₃, SrSnO₃, and BaSnO₃, and having been treated such that a molar ratio of alkaline earths to Sn in a surface region thereof is less than 1.

5. A plasma display panel that causes discharge in a discharge space by applying voltage between electrodes and causes phosphors to emit visible light by the discharge, wherein
the crystalline compound of claim 1 is disposed so as to face the discharge space.

6. A plasma display panel that causes discharge in a discharge space by applying voltage between electrodes and causes phosphors to emit visible light by the discharge, the plasma display panel comprising:
a first panel that includes:
a first substrate;
a first electrode positioned on the first substrate;
a first dielectric layer positioned on the first substrate so as to cover the first electrode; and
a protective layer positioned on the first dielectric layer and including MgO as a main component; and
a second panel that includes:
a second substrate;
a second electrode positioned on the second substrate;
a second dielectric layer positioned on the second substrate so as to cover the second electrode; and
a phosphor layer positioned on the second dielectric layer, wherein
the first panel and the second panel oppose each other with a discharge space therebetween, and
the crystalline compound of claim 1 is dispersed on the protective layer in particulate form.

7. The plasma display panel of claim 6, wherein
a ratio at which the dispersed crystalline compound covers the protective layer is in a range of 1% to 20% inclusive.

8. The plasma display panel of claim 7, wherein
a powder including MgO as a main component is further dispersed on the protective layer in particulate form.

9. A manufacturing method of a crystalline compound comprising:
a synthesizing step of synthesizing a crystalline compound selected from the group consisting of (i) CaSnO₃, (ii) SrSnO₃, (iii) BaSnO₃, and (iv) a solid solution of two or more selected from the group consisting of CaSnO₃, SrSnO₃, and BaSnO₃, and
a cleaning step of cleaning surfaces of the synthesized crystalline compound by using a polar solvent.

10. The manufacturing method of the crystalline compound of claim 9, wherein
in the cleaning step, the surfaces of the synthesized crystalline compound are cleaned using a solvent including water as a main component.

11. The manufacturing method of the crystalline compound of claim 9, wherein
in the cleaning step, a total amount of Ca, Sr, and Ba is reduced by 5% to 50% inclusive.

12. A plasma display panel that causes discharge in a discharge space by applying voltage between electrodes and causes phosphors to emit visible light by the discharge, wherein
the crystalline compound of claim 4 is disposed so as to face the discharge space.

13. A plasma display panel that causes discharge in a discharge space by applying voltage between electrodes and causes phosphors to emit visible light by the discharge, the plasma display panel comprising:
a first panel that includes:
a first substrate;
a first electrode positioned on the first substrate;
a first dielectric layer positioned on the first substrate so as to cover the first electrode; and
a protective layer positioned on the first dielectric layer and including MgO as a main component; and
a second panel that includes:
a second substrate;
a second electrode positioned on the second substrate;
a second dielectric layer positioned on the second substrate so as to cover the second electrode; and
a phosphor layer positioned on the second dielectric layer, wherein
the first panel and the second panel oppose each other with a discharge space therebetween, and
the crystalline compound of claim 4 is dispersed on the protective layer in particulate form.

14. The plasma display panel of claim 13, wherein
a ratio at which the dispersed crystalline compound covers the protective layer is in a range of 1% to 20% inclusive.

15. The plasma display panel of claim 14, wherein
a powder including MgO as a main component is further dispersed on the protective layer in particulate form.
